(19) United States
(12) Patent Application Publication
(10) Pub. No.: US 2025/0191475 A1
(43) Pub. Date: Jun. 12, 2025

(54) SYSTEMS AND METHODS FOR CLOUD-BASED FLIGHT PATH OPTIMIZATION FOR UNMANNED AERIAL VEHICLES

(71) Applicant: VayuAI Corp., MILL VALLEY, CA (US)

(72) Inventors: Jim KILES, MILL VALLEY, CA (US); Gelu VRABIE, MILL VALLEY, CA (US); August KILES

(21) Appl. No.: 18/770,553

(22) Filed: Jul. 11, 2024

Related U.S. Application Data
(63) Continuation of application No. PCT/US2023/060418, filed on Jan. 10, 2023.
(60) Provisional application No. 63/298,554, filed on Jan. 11, 2022.

(51) Int. Cl. G08G 5/34; G08G 5/57; G08G 5/76; G08G 5/80

(52) U.S. Cl. CPC G08G 5/34; G08G 5/57; G08G 5/76; G08G 5/80

(57) ABSTRACT

Techniques for flight path optimization include obtaining map information defining mapping coordinates of a geographical region, obtaining historical UAV-obtained flight information related to a first autonomous flight of a UAV in the geographical region based on a first flight plan, storing the map information, the historical UAV obtained-flight information, the first flight plan, and current values of a set of external factors separate from the flight information, and generating a second flight plan for a second autonomous flight of the UAV. The generating may include processing the map information, the historical UAV-obtained flight information, and the current values of the set of external factors, and updating the first flight plan based on the processing to generate the second flight plan. The second flight plan may be transmitted to the UAV for a second autonomous flight of the UAV in the geographical region.

### CROSS-REFERENCE TO RELATED APPLICATIONS

This application claims the benefit of priority to U.S. Provisional Patent Application No. 63/298,554, filed Jan. 11, 2022, which is incorporated herein by reference in its entirety.

### TECHNICAL FIELD

This application relates generally to unmanned aerial vehicles and more specifically to flight path optimization for unmanned aerial vehicles.

### BACKGROUND

In conventional systems involving unmanned aerial vehicles (UAVs), sense and avoid techniques for UAVs are unable to process and plan for unknown conditions in advance. Unknown conditions may include weather, other UAV movement or any other obstacles in flight-path movement. As such, the limited capability of conventional systems to use real-time sense and avoid systems to compare current conditions to historic conditions in the same environment have widely resulted in the reliance on human operators for processing unknown obstacles. Reliance on human operators can lead to an increase in cost and time and decrease in overall system efficiency. As such, there is a need to eliminate the reliance on human operators for UAV flying within range of a network hub enabling fully autonomous flight of multiple drones simultaneously.

### SUMMARY

The systems and methods described herein address one or more of the above-mentioned drawbacks by a system that enables the integration of programmed and fully autonomous UAV by combining a cloud-based flight optimization platform, an optional local network computational hub (connected to the cloud-based flight optimization platform) and a network-connected UAV operationally connected to the network hub and cloud-based flight optimization platform. The network-connected UAV may have autonomous sense and avoid software on board. The cloud-based flight optimization system presented herein may enable development and coordination of planned UAV movements, where environment conditions are subject to change including the appearance and intrusion of potential obstacles to safe movement or flight, including the movement of other UAV.

(A1) To that end, in accordance with some embodiments, a flight path optimization method utilized by a computing device in communication with one or more components of an autonomous unmanned aerial vehicle (UAV) is described. The method may include obtaining map information defining mapping coordinates of a geographical region, obtaining historical UAV-obtained flight information related to a first autonomous flight of a respective UAV in the geographical region, wherein the first autonomous flight of the UAV is based on a first flight plan provided to the UAV, storing, in a memory unit, the map information, the historical UAV obtained-flight information, the first flight plan, and current values of a set of external factors that are separate from the flight information and generating, using a processor, a second flight plan for a second autonomous flight of the UAV. The generating includes processing the map information, the historical UAV obtained-flight information, and the current values of the set of external factors, and updating the first flight plan based on the processing to generate the second flight plan, wherein the second flight plan is separate and distinct from the first flight plan, and transmitting, using the processor, the second flight plan to the UAV for a second autonomous flight of the UAV in the geographical region.

(A2) The method of (A1), wherein obtaining the historical UAV-obtained flight information includes: processing real-time UAV-obtained flight information related to flights of a plurality of UAVs to the geographical region, the real-time UAV-obtained flight information including at least one of: digital images, radar data, and Lidar data obtained by the plurality of UAVs (where “Lidar” is a known acronym for “light detection and ranging” or “laser imaging, detection, and ranging” techniques), and generating the historical UAV-obtained flight information based on the processed real-time UAV-obtained flight information.

(A3) The method of (A1), further comprising: generating, using the processor, the first flight plan based on the map information and previous values of the set of external factors; providing, using the processor, the first flight plan to the UAV; and launching the first autonomous flight of the UAV based on the first flight plan.

(A4) The method of (A1), wherein the historical UAV-obtained flight information includes information related to a deviation from the first flight plan during the first autonomous flight of the UAV.

(A5) The method of (A1)-(A4), wherein the deviation is caused due to an obstacle in a flight path detected by the UAV.

(A6) The method of claim (A1)-(A5), wherein the information related to the deviation includes an avoidance technique employed by the UAV to avoid the obstacle in the flight path.

(A7) The method of (A1)-(A4), wherein the deviation is caused due to one or more environmental conditions including a weather condition experienced by the UAV during the first autonomous flight.

(A8) The method of (A1)-(A2), wherein the historical UAV-obtained flight information includes digital images, radar data, Lidar data, or a combination thereof, obtained by the UAV during the first autonomous flight.

(A9) The method of (A1), wherein the set of external factors includes one or more of weather information, real-time UAV-obtained flight information related to a flight of another UAV to and in the geographical region, and a set of predefined flight restrictions for the geographical region.

(A10) The method of (A1), further comprising: transmitting an instruction to the UAV to abort the first autonomous flight and land at a specified location; and transmitting the second flight plan to the UAV after the UAV lands at the specified location, wherein the UAV is launched for the second autonomous flight according to the second flight plan.

(A11) The method of (A1), further comprising transmitting an instruction to the UAV to implement the second flight plan during the first autonomous flight without prematurely terminating the first autonomous flight of the UAV.

(A12) The method of (A1), further comprising establishing a communication channel with a network hub, which is communicatively connected with the UAV, wherein the obtaining map information, the obtaining historical UAV-obtained flight information, and the transmitting the second flight plan to the UAV is performed via the network hub.

(B1) In accordance with some embodiments, a system is described. The system may include: a communication module in communication with an autonomous unmanned aerial vehicle (UAV); one or more processors; and a memory unit storing instructions operable to cause the one or more processors to implement one or more operations. The operations may include: obtaining, via the communication module, map information defining mapping coordinates of a geographical region, obtaining, via the communication module, historical UAV-obtained flight information related to a first autonomous flight of the UAV to and in the geographical region, wherein the first autonomous flight of the UAV is based on a first flight plan provided to the UAV, storing, in the memory unit, the map information, the historical UAV-obtained flight information, the first flight plan, and current values of a set of external factors that are separate from the historical UAV-obtained flight information; generating a second flight plan for a second autonomous flight of the UAV, the generating including: processing the map information, the historical UAV-obtained flight information, and the current values of the set of external factors, and updating the first flight plan based on the processing to generate the second flight plan; and transmitting, via the communication module, the second flight plan to the UAV for a second autonomous flight of the UAV to and in the geographical region.

(B2) The system of (B1), wherein the obtaining the map information includes: processing real-time UAV-obtained flight information related to flights of a plurality of UAVs to the geographical region, the real-time UAV-obtained flight information including at least one of: digital images, radar data and Lidar data obtained by the plurality of UAVs, and generating the historical UAV-obtained flight information based on the processed real-time UAV-obtained flight information.

(B3) The system of (B2), wherein the operations further include: generating, the first flight plan based on the map information and previous values of the set of external factors; providing, via the communication module, the first flight plan to the UAV; and launching the first autonomous flight of the UAV based on the first flight plan.

(B4) The system of (B1), wherein the historical UAV-obtained flight information includes information related to a deviation from the first flight plan during the first autonomous flight of the UAV.

(B5) The system of (B4), wherein the deviation is caused due to an obstacle in a flight path detected by the UAV.

(B6) The system of claim (B5), wherein the information related to the deviation includes an avoidance technique employed by the UAV to avoid the obstacle in the flight path.

(B7) The system of claim (B2), wherein the historical UAV-obtained flight information includes digital images, radar data, Lidar data, or a combination thereof, obtained by the UAV during the first autonomous flight.

(B8) The system of claim (B1), wherein the set of external factors includes one or more of weather information, historical UAV-obtained flight information related to a flight of another UAV to and in the geographical region, and a set of predefined flight restrictions for the geographical region.

(B9) The system of claim (B1), wherein the operations further include: transmitting, via the communication module, an instruction to the UAV to abort the first autonomous flight and land at a specified location; and transmitting, via the communication module, the second flight plan to the UAV after the UAV lands at the specified location, wherein the UAV is launched for the second autonomous flight according to the second flight plan. The system of claim (B1), wherein the operations further include transmitting, via the communication module, an instruction to the UAV to implement the second flight plan during the first autonomous flight without prematurely terminating the first autonomous flight of the UAV.

(B10) The system of (B1), further including a network hub, the operations further include establishing a communication channel with the network hub, which is communicatively connected with the UAV, wherein the obtaining map information, the obtaining historical UAV-obtained flight information, and the transmitting the second flight plan to the UAV is performed via the network hub.

(B11) The system of (B1), wherein the processing the map information, the historical UAV-obtained flight information, and the current values of the set of external factors, includes: applying a predictive machine learning model to the map information and the current values of the set of external factors to determine optimized flight information, wherein the predictive machine learning model was previously trained by analyzing historical UAV-obtained flight information to determine the optimized flight information representing improved flight information for subsequent flight plans.

### BRIEF DESCRIPTION OF THE DRAWINGS

For a better understanding of the various described implementations, reference should be made to the Detailed Description below, in conjunction with the following drawings in which like reference numerals refer to corresponding parts throughout the figures.

FIG. 1A illustrates cloud-based optimization for a UAV platform, in accordance with some embodiments.

FIG. 1B illustrates two exemplary flight plans for multiple UAVs.

FIG. 2 illustrates a first embodiment of the cloud-based optimization for a UAV depicted in FIG. 1, in accordance with some embodiments.

FIG. 3 illustrates a second embodiment of the cloud-based optimization for a UAV depicted in FIG. 1, in accordance with some embodiments.

FIGS. 4A and 4B illustrate a flowchart of a flight path optimization method, in accordance with some embodiments.

### DETAILED DESCRIPTION

Reference will now be made in detail to implementations, examples of which are illustrated in the accompanying drawings. In the following detailed description, numerous specific details are set forth in order to provide a thorough understanding of the various described implementations. However, it will be apparent to one of ordinary skill in the art that the various described implementations may be practiced without these specific details. In other instances, well-known methods, procedures, components, circuits, and networks have not been described in detail so as not to unnecessarily obscure aspects of the implementations.

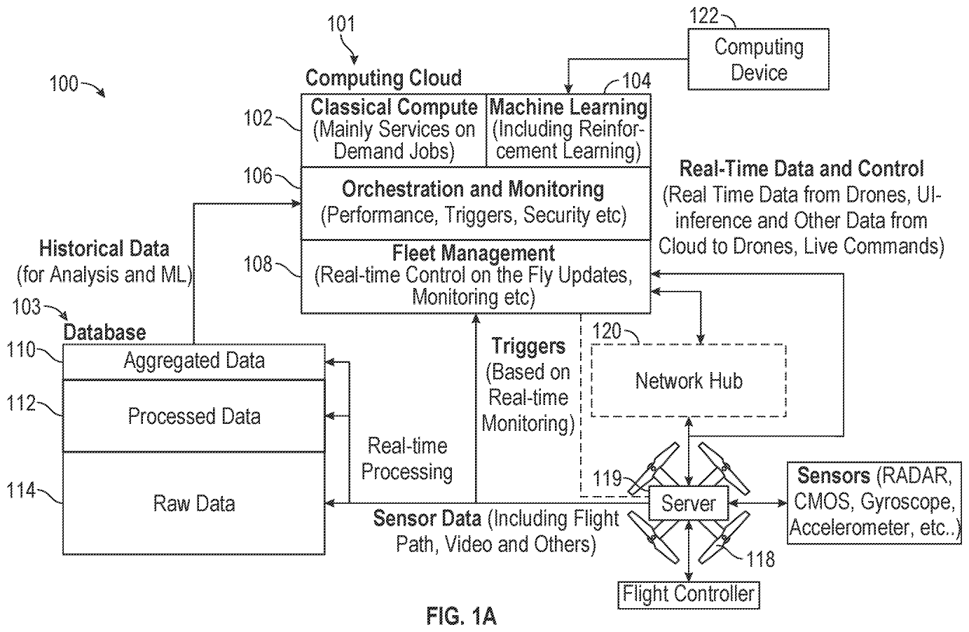

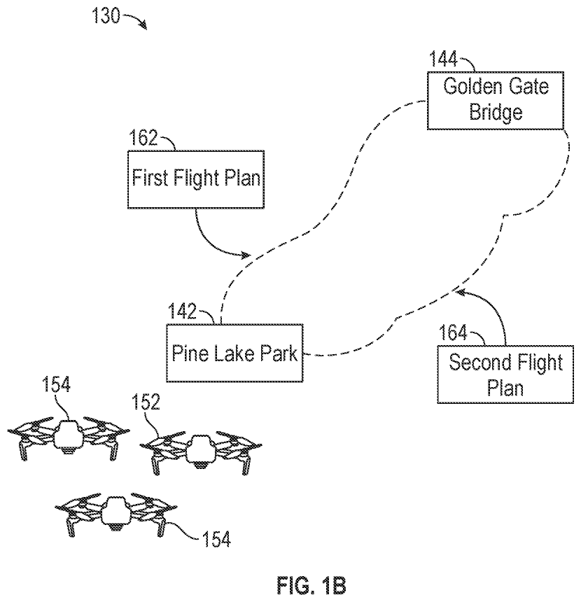

FIG. 1A illustrates a cloud-based optimization for a UAV system 100 and FIG. 1B illustrates two exemplary flight plans for multiple UAVs.

The cloud-based optimization for UAV system 100 may include computing cloud module 101, computing device 122 communicating with computing cloud module 101, a database module 103 (operationally connected to the computing cloud module 101) and a network connected UAV 118 operationally connected to the database 103 and the computing cloud module 101. Optionally, cloud-based optimization for a UAV system 100 may also include a network hub 120 that communicates with both the network-connected UAV 118 and computing cloud module 101. Network-connected UAV 118 can communicate over a wireless and/or a wired network (e.g., a network configured according to the 3GPP standards, such as a 5G network) to send data from sensors on board network-connected UAV 118 to computing cloud module 101. Using the data, real time integration of cloud systems intelligence and flight optimization is processed, as described in more detail below.

Computing cloud module 101, in communication with computing device 122, obtains map information defining mapping coordinates of a geographical region. For example, computing device 122 obtains map information for San Francisco, including global positioning system (GPS) coordinates for San Francisco, California of 37° 46′ 26.2992″ N and 122° 25′ 52.6692″ W, as well as GPS coordinates for all locations within San Francisco, California. Map information may also include areas where UAV are not permitted to travel (e.g., no fly zones). After obtaining map information defining mapping coordinates for San Francisco, California, computing cloud module 101 obtains historical UAV-obtained flight information for a first (or previously-completed) autonomous flight of a UAV (e.g., a first flight from pink lake park to golden gate bridge for UAV 118) in the geographical region. In some embodiments, machine learning module 104 stores historical data from database 103 to determine best routes for future flight paths of network-connected UAV 118.

The first autonomous flight of network-connected is based on a first flight plan (e.g., first flight plan 162 depicted in FIG. 1B), provided to the network-connected UAV 118. For example, the first flight plan 162 for network-connected UAV 118 may include traveling from pine lake park to golden gate bridge using a specific or pre-determined route.

In some embodiments, the first flight plan 162 may include deviations (e.g., any obstacle obstructing the flight path, including but not limited to: a hot air balloon, fireworks or hazardous weather conditions). In some embodiments, in order to determine if deviations exist in the flight path, the computing device 122 obtains historical data related to flights of one or several UAVs from pine lake park to golden gate bridge (as shown in FIG. 1B). The historical UAV-obtained flight information includes information related to a deviation from the first flight plan 162 during the first autonomous flight of the UAV. For example, computing device 122 obtains historical data related to flights of UAVs 152, 154 and 156 shown in FIG. 1B, for respective flights where UAV 152, UAV 154, and UAV 156, respectively traveled from pine lake park 142 to golden gate bridge 144 using first flight plan 162, which includes weather-related turbulence encountered by each of the respective flights during their respective autonomous flights. Information related to the deviation encountered by one or more UAV (e.g., UAV 152, UAV 154 and UAV 156) includes an avoidance technique employed by the UAV to avoid the obstacle in the flight path.

Obtaining the historical data related to flights of UAVs 152, 154 and 156 includes processing real-time UAV-obtained flight information related to flights of a plurality of UAVs to the geographical region (e.g., processing real-time UAV-obtained flight information related to UAV 152 using first flight plan 162). The real-time UAV-obtained flight information includes at least one of digital images, radar data, and Lidar data obtained by the plurality of UAVs, and generates the historical UAV-obtained flight information based on the processed real-time UAV-obtained flight information.

Computing cloud module 101 stores, in machine learning module 104 the map information (e.g., map information defining mapping coordinates for San Francisco, California and various locations within San Francisco), the historical UAV-obtained flight information (the historical flight data obtained for UAV 150, UAV 152 and UAV 154 traveling from pine lake park 142 to golden gate bridge 144), the first flight plan (e.g., first flight plan 162 shown in FIG. 1B), and current values of a set of external factors that are separate from the flight information. For example, the set of external factors includes one or more of weather information (e.g., temperature data, changes of precipitation, cloudy or foggy conditions, etc.), real-time UAV-obtained flight information related to a flight of another UAV to and in the geographical region, and a set of predefined flight restrictions for the geographical region (e.g., any air restrictions for first flight plan 162). Machine learning module 104 may accommodate machine learning algorithms and probabilistic models, requiring substantial computing power. Computing cloud module 101 includes all data from a network-connected UAV that is stored in the cloud and accessed through the web, including optimizations and calculations of various flight paths of a UAV.

Real-time and control data associated with network-connected UAV 118 includes local Supervisory Control and Data Acquisition (SCADA), machine learning inference, real-time data from network-connected UAV 118, live commands on-board network-connected UAV and other miscellaneous data may be transferred to computing cloud module 101 from UAV server 119 (on-board network-connected UAV 118). Data from computing cloud module 101 quickly and efficiently transfers to UAV server 119. Alternatively, data from UAV server 119 quickly and efficiently transfers to computing cloud module 101.

UAV server 119 performs data acquisition and transmission, captured by sensor systems on UAV (e.g., network-connected UAV 118 in FIG. 1A). The data acquisition and transmission captured by sensor systems on network-connected UAV 118 may include a data acquisition system and a router. The data acquisition system, such as a SCADA system, may receive UAV conditions and transmit this information to the computing cloud module 101

In some embodiments, in order to avoid the deviations identified by the historical UAV-obtained flight information for a first flight of one or several UAVs using first flight plan 162, the computing device may generate, via computing cloud module 101, a second flight plan 164 (e.g., first flight plan 162 uses a first distinct route and second flight plan 164 uses a second distinct route). Computing device 122 generates, via computing cloud module 101, a second flight plan 164 for a second autonomous flight for network connected UAV 118. For example, computing device 122 generates second flight plan 164 that is distinct from first flight plan 162 and that avoids the deviations identified in the first flight plan 162. Generating, (e.g., via computing cloud module 101), the second flight plan 164 includes processing the map information, the historical UAV-obtained flight information (e.g., historical flight information obtained from UAV 152, 154 and 156), and the current values of the set of external factors. Computing cloud module 101 updates the first flight plan (e.g., flight plan 162) based on processing the map information, the historical UAV-obtained flight information, and the current values of the set of external factors, to generate the second flight plan. The second flight plan (e.g., second flight plan 164) is separate and distinct from the first flight plan (e.g., first flight plan 162). Computing device 122 transmits, using the processor, the second flight plan 164 to the UAV for a second autonomous flight of the UAV in the geographical region.

Computing cloud module 101 transmits an instruction to the UAV server 119 to abort the first autonomous flight (e.g., first flight using first flight plan 162) and land at a specified location. For example, network-connected UAV 118 may launch a first flight using first flight plan 162 during which computing cloud module 101 determines that first flight plan 162 is no longer the best route for various reasons, discussed above. UAV server 119 transmits the second flight plan 164 to the network-connected UAV 118 after the network connected UAV 118 lands at a specified location. For example, the specific location may be a location between pine lake park 142 and golden gate bridge 144. After landing at the specified location, the network-connected UAV 118 is launched for the second autonomous flight according to the second flight plan 164. In some embodiments, the computing cloud module 101 transmits the instructions to the network-connected UAV 118 to implement the second flight plan 164 during the first autonomous flight without prematurely terminating the first autonomous flight of the network-connected UAV 118.

In some embodiments, computing device 122 determines, via computing cloud module 101, that deviations are not identified from the historical UAV-obtained flight information for a first flight of one or several UAVs using first flight plan 162. As a result of determining that deviations or obstacles are not identified, the historical UAV-obtained flight information for a first flight of one or several UAVs (e.g., UAV 152, 154 and 156), the computing cloud module 101 generates the first flight plan 162 (e.g., a flight plan using a unique route from pine lake park 142 to golden gate bridge 144). The first flight plan 162 is based on the map information and previous values of the set of external factors. The first flight plan 162 is sent from computing cloud module 101 to the network-connected UAV. Launching the first autonomous flight of the UAV based on the first flight plan. As a result, the network-connected UAV launches the first autonomous flight based on the first flight plan 162.

In some embodiments, the network-connected UAV 118 is unable to establish a connection with computing cloud module 101. As such, computing cloud module 101 establishes a connection with network hub 120, which is communicatively connected with the network-connected UAV 118. As a result, the steps explained above for cloud-computing module 102 for obtaining map information, obtaining historical UAV-obtained flight information, and transmitting a flight plan (e.g., first flight plan 162 or second flight plan 164) to the UAV are performed via the network hub 120. The network hub 120 receives UAV conditions and generates SCADA data. Local data SCADA may include UAV parameter, a performance parameter, speed parameter, a temperature parameter, etc. Network hub 120 can include UAV calculations sent to computing cloud 101 and accessed locally.

The computing cloud 101 may comprise of a classical compute module 102, a machine learning module 104, an orchestration and monitoring module 106 and a fleet management module 108. Classical compute module 102 may be a serverless module for on demand jobs. Orchestration and monitoring module 106 may include performance data for various components, triggers and security architecture. Orchestration and monitoring module 106 may provide service for high-speed feedback loops between the remote UAV server 119 and database module 103. Fleet management module 108 regulates real-time control of network-connected UAV 118, including real-time updates and monitoring.

In some embodiments, network-connected UAV 118 may include various sensors such as RADAR, CMOS, gyroscope, accelerometer, etc. Sensor data from network-connected UAV 118 is sent to database 103 for processing. Sensor data may include flight path of the network-connected UAV 118, video and audio data from UAV 118. The network-connected UAV 118 may include an autonomous sense and avoid software module on board the UAV.

Database 103 may be a data processing system where real-time processing of sensor data for UAV 118 occurs. Database 103 may include aggregated data 110, processed data 112 and raw data 114. Database 103 may also include historical data, which may be sent to the computing cloud module 101 when the historical data is needed by the machine learning system 104 to determine if another flight path is more favorable for a UAV.

Database 103 may include one or more processor(s) that communicate with a number of peripheral devices via a bus subsystem. These peripheral devices may include input device(s), output device(s), communication network interface, and a storage subsystem, such as a volatile memory and a nonvolatile memory. The volatile memory and/or the nonvolatile memory may store computer-executable instructions and thus forming logic that when applied to and executed by the processor(s) implement embodiments of the processes disclosed herein.

The input device(s) include devices and mechanisms for inputting information to the data processing system. These may include a keyboard, a keypad, a touch screen incorporated into the monitor or graphical user interface, audio input devices such as voice recognition systems, microphones, and other types of input devices. In various embodiments, the input device(s) may be embodied as a computer mouse, a trackball, a track pad, a joystick, wireless remote, drawing tablet, voice command system, eye tracking system, and the like. The input device(s) typically allow a user to select objects, icons, control areas, text and the like that appear on the monitor or graphical user interface via a command such as a click of a button or the like.

The output device(s) include devices and mechanisms for outputting information from the data processing system 103. These may include the monitor or graphical user interface, speakers, printers, infrared LEDs, and so on as well understood in the art.

The communication network interface provides an interface to communication networks (e.g., communication network) and devices external to the data processing system 820. The communication network interface may serve as an interface for receiving data from and transmitting data to other systems. Embodiments of the communication network interface may include an Ethernet interface, a modem (telephone, satellite, cable, ISDN), (asynchronous) digital subscriber line (DSL), FireWire, USB, a wireless communication interface such as BlueTooth or WiFi, a near field communication wireless interface, a cellular interface, and the like.

The communication network interface may be coupled to the communication network via an antenna, a cable, or the like. In some embodiments, the communication network interface may be physically integrated on a circuit board of the data processing system, or in some cases may be implemented in software or firmware, such as “soft modems”, or the like.

The computing device may include logic that enables communications over a network using protocols such as HTTP, TCP/IP, RTP/RTSP, IPX, UDP and the like.

The volatile memory and the nonvolatile memory are examples of tangible media configured to store computer readable data and instructions to implement various embodiments of the processes described herein. Other types of tangible media include removable memory (e.g., pluggable USB memory devices, mobile device SIM cards), optical storage media such as CD-ROMS, DVDs, semiconductor memories such as flash memories, non-transitory read-only-memories (ROMS), battery-backed volatile memories, networked storage devices, and the like. The volatile memory and the nonvolatile memory may be configured to store the basic programming and data constructs that provide the functionality of the disclosed processes and other embodiments thereof that fall within the scope of the present invention.

Logic that implements embodiments of the present invention may be stored in the volatile memory and/or the nonvolatile memory. Said logic may be read from the volatile memory and/or nonvolatile memory and executed by the processor(s). The volatile memory and the nonvolatile memory may also provide a repository for storing data used by the logic.

The volatile memory and the nonvolatile memory may include a number of memories including a main random-access memory (RAM) for storage of instructions and data during program execution and a read only memory (ROM) in which read-only non-transitory instructions are stored. The volatile memory and the nonvolatile memory may include a file storage subsystem providing persistent (non-volatile) storage for program and data files. The volatile memory and the nonvolatile memory may include removable storage systems, such as removable flash memory.

The bus subsystem provides a mechanism for enabling the various components and subsystems of data processing system 103 communicate with each other as intended.

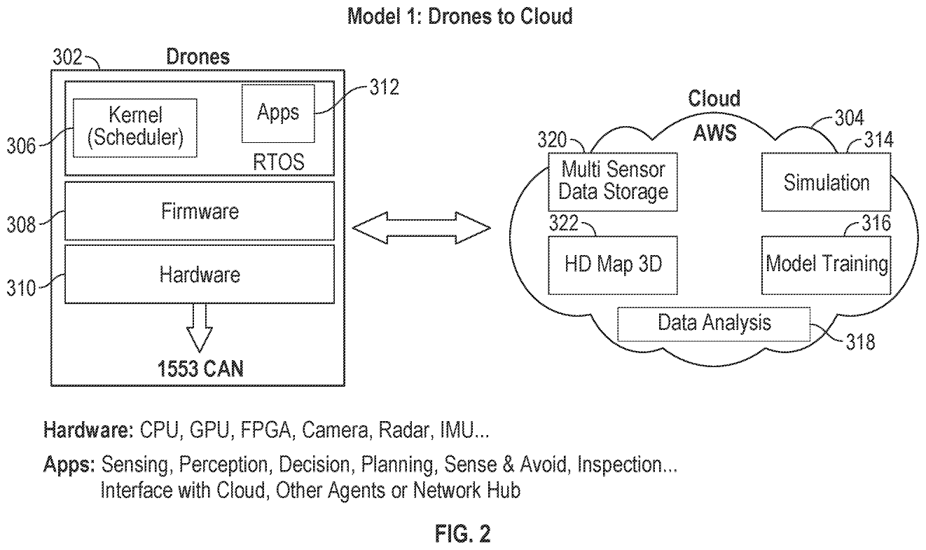

FIG. 2 illustrates a first embodiment of the cloud-based optimization for a network-connected UAV, in accordance with some embodiments. The first embodiment depicted is a cloud-based system for flight path optimization. In some embodiments, the network-connected UAV 118 described above may be drone 302. Drone 302 may be an individual network-connected UAV or a fleet of network-connected UAVs. Embodiments described above for network-connected UAV 118 may be applicable to drone 302. Drone 302 may include a scheduler system 306, applications system 312, firmware system 308 and hardware system 310. Applications system 312 on board drone 302 may include sensing, perception, decision, planning, sense and avoid and inspection applications. Hardware system 310 may include CPU, GPU, FPGA, camera, radar and IMU sensors.

Drone 302 may communicate with cloud-based optimization platform 304 (e.g., computing cloud 101 described above in reference to FIG. 1A). Embodiments described above for computing cloud module 101 may be applicable to cloud-based optimization platform 304. Cloud-based optimization platform 304 may include multi-sensor data storage module 320, HD 3D map module 322, model training module 316, simulation module 314 and data analytics module 318. Multi-sensor data storage module 320 can include all data collected by various sensors of drone 302 (e.g., accelerometer data, gyroscope data, barometer data, magnetometer data). Simulation module 314 can include simulations for various flight paths (e.g., first flight path 162) in order to study the best route based on historical UAV-obtained flight information related to a first autonomous flight of a respective UAV in the geographical region. Model training module 316 can include various trained models for one or more various flight paths. Data analytics module 318 can include

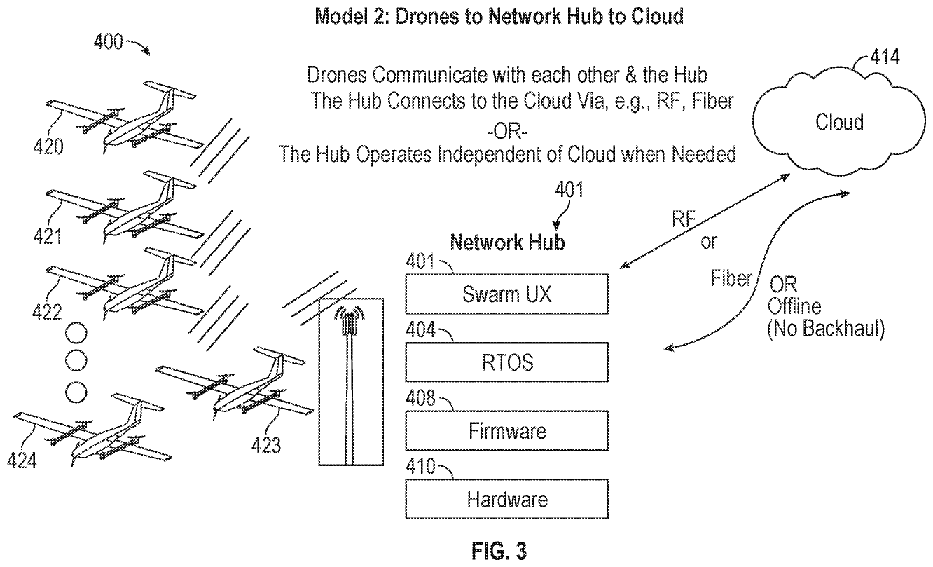

FIG. 3 illustrates a second embodiment of the cloud-based optimization, in accordance with some embodiments. In the depicted second embodiment, the fleet of network-connected UAVs 400 (e.g., UAV 420-424) communicate with each other and the network hub 402, instead of communicating directly with the cloud (e.g., computing cloud module 101). In some embodiments, the fleet of network-connected UAVs 400 may be unable to connect to the cloud 414, in which cases a network hub 402 is useful. In some embodiments, the network hub 402 communicates with the fleet of network-connected UAVs 400 and also communicates with cloud 414. In some embodiments, the characteristics described above for computing cloud module 101 are applicable to cloud 414. The network hub 402 operates independent of cloud 414 when necessary. Network hub 402 is connected to cloud 414 through RF or fiber communication. Network hub 401 includes swarm UX 401, real-time operating system (RTOS) 404, firmware 408 and hardware 410.

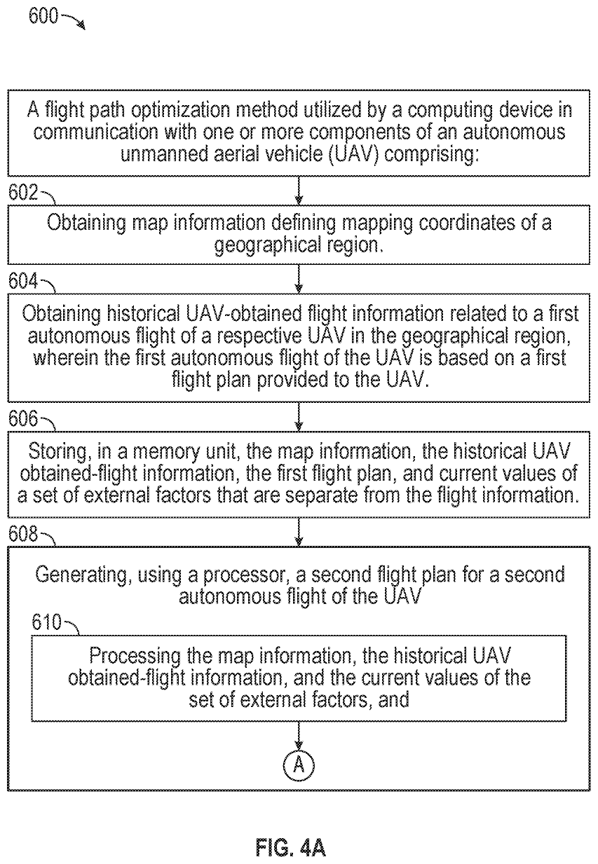

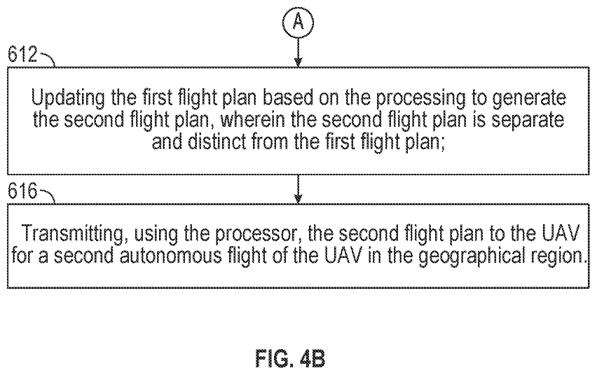

FIGS. 4A and 4B illustrate a flowchart of a flight path optimization method, in accordance with some embodiments.

A flight path optimization method 600 utilized by a computing device in communication with one or more components of an autonomous unmanned aerial vehicle (UAV).

The method 600 includes, obtaining (602) map information defining mapping coordinates of a geographical region. For example, the one or more network-connected UAV 118 depicted in FIG. 1A may be located in a geographical region with specific mapping coordinates.

The method 600 further includes, obtaining (604) historical UAV-obtained flight information related to a first autonomous flight of a respective UAV in the geographical region, wherein the first autonomous flight of the UAV is based on a first flight plan provided to the UAV. For example, a number of other UAV may have traversed a similar first flight plan provided the UAV which is contained in the historical UAV-obtained flight information. The historical UAV-obtained flight information may have data related to obstacles, weather and other interference related data for the first flight plan. As shown in FIG. 1A, historical data that is stored in database 103 may be sent to the machine learning module 104 in computing cloud 101 for analysis.

The method 600 further includes, storing (606), in a memory unit, the map information, the historical UAV obtained-flight information, the first flight plan, and current values of a set of external factors that are separate from the flight information. For example, database 103 in FIG. 1A may store the map information, the historical UAV obtained-flight information, the first flight plan, and current values of a set of external factors that are separate from the flight information.

The method 600 further includes, generating (608), using a processor, a second flight plan (e.g., second flight plan 164) for a second autonomous flight of the UAV. The generating 608 includes, processing (610) the map information, the historical UAV obtained-flight information, and the current values of the set of external factors. The generating 608 further includes updating (612) the first flight plan (e.g., first flight plan 162) based on the processing to generate the second flight plan (e.g., second flight plan 162), wherein the second flight plan is separate and distinct from the first flight plan. The generating 608 further includes storing (614), in the memory unit, the second flight plan and transmitting (616), using the processor, the second flight plan to the UAV (e.g., network-connected UAV 118) for a second autonomous flight of the UAV in the geographical region (e.g., geographical region 130 in FIG. 1B). For example, as shown in FIGS. 1A and 1B, machine learning module 104 may generate a second autonomous flight plan by processing the geographical location of the UAV 118, the historical UAV obtained information and values of external factors. External factors may include weather information, real-time UAV-obtained flight information related to a flight of another UAV to and in the geographical region, and a set of predefined flight restrictions for the geographical region. Generating a second autonomous flight plan for UAV (network-connected UAV 118) may also include updating a first flight plan (e.g., first flight plan 162) of network-connected UAV 118 by storing in database 103 the second flight plan and transmitting to UAV the second autonomous flight plan to UAV 118.

Terms used herein should be accorded their ordinary meaning in the relevant arts, or the meaning indicated by their use in context, but if an express definition is provided, that meaning controls.

“Circuitry” in this context refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment).

“Firmware” in this context refers to software logic embodied as processor-executable instructions stored in read-only memories or media.

“Hardware” in this context refers to logic embodied as analog or digital circuitry.

“Logic” in this context refers to machine memory circuits, non-transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

“Software” in this context refers to logic implemented as processor-executable instructions in a machine memory (e.g. read/write volatile or nonvolatile memory or media).

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

Various logic functional operations described herein may be implemented in logic that is referred to using a noun or noun phrase reflecting said operation or function. For example, an association operation may be carried out by an “associator” or “correlator.” Likewise, switching may be carried out by a “switch”, selection by a “selector,” and so on.

The methods and systems in this disclosure are described in the preceding on the basis of several preferred embodiments. Different aspects of different variants are considered to be described in combination with each other such that all combinations that upon reading by a skilled person in the field on the basis of this document may be regarded as being read within the concept of the invention. The preferred embodiments do not limit the extent of protection of this document.

Having thus described embodiments of the present invention of the present application in detail and by reference to illustrative embodiments thereof, it will be apparent that modifications and variations are possible without departing from the scope of the present invention.

It will be understood that, although the terms first, second, etc., are, in some instances, used herein to describe various elements, these elements should not be limited by these terms. These terms are only used to distinguish one element from another. For example, a first widget could be termed a second widget, and, similarly, a second widget could be termed a first widget, without departing from the scope of the various described implementations. The first widget and the second widget are both widget, but they are not the same condition unless explicitly stated as such.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The foregoing description, for purpose of explanation, has been described with reference to specific implementations. However, the illustrative discussions above are not intended to be exhaustive or to limit the scope of the claims to the precise forms disclosed. Many modifications and variations are possible in view of the above teachings. The implementations were chosen in order to best explain the principles underlying the claims and their practical applications, to thereby enable others skilled in the art to best use the implementations with various modifications as are suited to the particular uses contemplated.

What is claimed is:

1. A flight path optimization method utilized by a computing device in communication with one or more components of an autonomous unmanned aerial vehicle (UAV) comprising:
obtaining map information defining mapping coordinates of a geographical region;
obtaining historical UAV-obtained flight information related to a first autonomous flight of a respective UAV in the geographical region, wherein the first autonomous flight of the UAV is based on a first flight plan provided to the UAV;
storing, in a memory unit, the map information, the historical UAV-obtained flight information, the first flight plan, and current values of a set of external factors that are separate from the flight information;
generating, using a processor, a second flight plan for a second autonomous flight of the UAV, the generating including:
processing the map information, the historical UAV-obtained flight information, and the current values of the set of external factors, and
updating the first flight plan based on the processing to generate the second flight plan, wherein the second flight plan is separate and distinct from the first flight plan; and
transmitting, using the processor, the second flight plan to the UAV for a second autonomous flight of the UAV in the geographical region.

2. The method of claim 1, wherein the obtaining the historical UAV-obtained flight information includes:
processing real-time UAV-obtained flight information related to flights of a plurality of UAVs to the geographical region, the real-time UAV-obtained flight information including at least one of: digital images, radar data, and Lidar data obtained by the plurality of UAVs, and
generating the historical UAV-obtained flight information based on the processed real-time UAV-obtained flight information.

3. The method of claim 1, further comprising:
generating, using the processor, the first flight plan based on the map information and previous values of the set of external factors;
providing, using the processor, the first flight plan to the UAV; and
launching the first autonomous flight of the UAV based on the first flight plan.

4. The method of claim 1, wherein the historical UAV-obtained flight information includes information related to a deviation from the first flight plan during the first autonomous flight of the UAV.

5. The method of claim 4, wherein the deviation is caused due to an obstacle in a flight path detected by the UAV.

6. The method of claim 5, wherein the information related to the deviation includes an avoidance technique employed by the UAV to avoid the obstacle in the flight path.

7. The method of claim 4, wherein the deviation is caused due to one or more environmental conditions including a weather condition experienced by the UAV during the first autonomous flight.

8. The method of claim 2, wherein the historical UAV-obtained flight information includes digital images, radar data, Lidar data, or a combination thereof, obtained by the UAV during the first autonomous flight.

9. The method of claim 1, wherein the set of external factors includes one or more of weather information, real-time UAV-obtained flight information related to a flight of another UAV to and in the geographical region, and a set of predefined flight restrictions for the geographical region.

10. The method of claim 1, further comprising:
transmitting an instruction to the UAV to abort the first autonomous flight and land at a specified location; and
transmitting the second flight plan to the UAV after the UAV lands at the specified location, wherein the UAV is launched for the second autonomous flight according to the second flight plan.

11. The method of claim 1, further comprising transmitting an instruction to the UAV to implement the second flight plan during the first autonomous flight without prematurely terminating the first autonomous flight of the UAV.

12. The method of claim 1, further comprising establishing a communication channel with a network hub, which is communicatively connected with the UAV, wherein the obtaining map information, the obtaining historical UAV-obtained flight information, and the transmitting the second flight plan to the UAV is performed via the network hub.

13. A system comprising:
a communication module in communication with an autonomous unmanned aerial vehicle (UAV);
one or more processors; and
a memory unit storing instructions operable to cause the one or more processors to implement operations including:
obtaining, via the communication module, map information defining mapping coordinates of a geographical region,
obtaining, via the communication module, historical UAV-obtained flight information related to a first autonomous flight of the UAV to and in the geographical region, wherein the first autonomous flight of the UAV is based on a first flight plan provided to the UAV,
storing, in the memory unit, the map information, the historical UAV-obtained flight information, the first flight plan, and current values of a set of external factors that are separate from the historical UAV-obtained flight information;
generating a second flight plan for a second autonomous flight of the UAV, the generating including:
processing the map information, the historical UAV-obtained flight information, and the current values of the set of external factors, and
updating the first flight plan based on the processing to generate the second flight plan;
and
transmitting, via the communication module, the second flight plan to the UAV for a second autonomous flight of the UAV to and in the geographical region.

14. The system of claim 13, wherein the obtaining the map information includes:
processing real-time UAV-obtained flight information related to flights of a plurality of UAVs to the geographical region, the real-time UAV-obtained flight information including at least one of: digital images, radar data, and Lidar data obtained by the plurality of UAVs, and
generating the historical UAV-obtained flight information based on the processed real-time UAV-obtained flight information.

15. The system of claim 13, wherein the operations further include:
generating the first flight plan based on the map information and previous values of the set of external factors;
providing, via the communication module, the first flight plan to the UAV; and
launching the first autonomous flight of the UAV based on the first flight plan.

16. The system of claim 13, wherein the historical UAV-obtained flight information includes information related to a deviation from the first flight plan during the first autonomous flight of the UAV.

17. The system of claim 16, wherein the deviation is caused due to an obstacle in a flight path detected by the UAV.

18. The system of claim 17, wherein the information related to the deviation includes an avoidance technique employed by the UAV to avoid the obstacle in the flight path.

19. The system of claim 14, wherein the historical UAV-obtained flight information includes digital images, radar data, Lidar data, or a combination thereof, obtained by the UAV during the first autonomous flight.

20. The system of claim 13, wherein the set of external factors includes one or more of weather information, historical UAV-obtained flight information related to a flight of another UAV to and in the geographical region, and a set of predefined flight restrictions for the geographical region.

21. The system of claim 13, wherein the operations further include:
transmitting, via the communication module, an instruction to the UAV to abort the first autonomous flight and land at a specified location; and
transmitting, via the communication module, the second flight plan to the UAV after the UAV lands at the specified location, wherein the UAV is launched for the second autonomous flight according to the second flight plan.

22. The system of claim 13, wherein the operations further include transmitting, via the communication module, an instruction to the UAV to implement the second flight plan during the first autonomous flight without prematurely terminating the first autonomous flight of the UAV.

23. The system of claim 13, further comprising a network hub, wherein the operations further include establishing a communication channel with the network hub, which is communicatively connected with the UAV, wherein the obtaining map information, the obtaining historical UAV-obtained flight information, and the transmitting the second flight plan to the UAV is performed via the network hub.

24. The system of claim 13, wherein the processing the map information, the historical UAV-obtained flight information, and the current values of the set of external factors, includes: applying a predictive machine learning model to the map information and the current values of the set of external factors to determine optimized flight information, wherein the predictive machine learning model was previously trained by analyzing historical UAV-obtained flight information to determine the optimized flight information representing improved flight information for subsequent flight plans.
